(19) United States
(12) Patent Application Publication
(10) Pub. No.: US 2011/0007099 A1
(43) Pub. Date: Jan. 13, 2011

(54) INVERTER CIRCUIT, BACKLIGHT DEVICE AND DISPLAY DEVICE

(75) Inventor: Masahiro Arai, Osaka (JP)

Correspondence Address: HARNESS, DICKEY & PIERCE, P.L.C., P.O. BOX 8910, RESTON, VA, 20195, US

(73) Assignee: Sharp Kabushiki Kaisha, Osaka-shi, Osaka (JP)

(21) Appl. No.: 12/736,119

(22) PCT Filed: Nov. 10, 2008
(86) PCT No.: PCT/JP2008/070384

§ 371 Date: Sep. 10, 2010

(30) Foreign Application Priority Data
Apr. 3, 2008 (JP) 2008/097463

(51) Int. Cl. G09G 5/10; H05B 41/36

(52) U.S. Cl. 345/690; 315/276; 315/255

(57) ABSTRACT

Provided is an inverter circuit capable of suppressing an increase in EMI level. In at least one embodiment, the inverter circuit includes: a drive circuit for outputting a pulse signal; a transformer for outputting a drive signal corresponding to the pulse signal to a fluorescent lamp, the transformer including a secondary winding having one end connected to the fluorescent lamp; a detection control circuit for detecting a detection signal corresponding to the drive signal supplied to the fluorescent lamp; a wiring line connecting another end of the secondary winding of the transformer and the detection control circuit; and a wiring line provided together with the wiring line so that magnetic fields generated are cancelled out each other.

### TECHNICAL FIELD

The present invention relates to an inverter circuit, a backlight device, and a display device, and more particularly, to an inverter circuit for driving a fluorescent lamp, and a backlight device and a display device including the inverter circuit.

### BACKGROUND ART

Up to now, a backlight device including an inverter circuit for driving a fluorescent lamp is known (see, for example, Patent Document 1). Patent Document 1 discloses a backlight (backlight device) including a cold cathode tube (fluorescent lamp) and an inverter circuit. The inverter circuit includes a drive circuit for driving the cold cathode tube, a transformer connected to the cold cathode tube and the drive circuit, a tube current detection circuit connected to the cold cathode tube to detect a tube current flowing through the cold cathode tube, and an oscillation circuit connected to the tube current detection circuit and the drive circuit.

In the above Patent Document 1, the tube current detection circuit detects the tube current flowing through the cold cathode tube and, based on the detected tube current, the oscillation circuit controls a signal to be output to the drive circuit and the transformer. Accordingly, a current (tube current) to be output from the transformer to the cold cathode tube is controlled.

Patent Document 1: JP 2006-39345 A

### DISCLOSURE OF THE INVENTION

### Problem to be Solved by the Invention

However, in the backlight device as disclosed in the above Patent Document 1, the cold cathode tube (fluorescent lamp) is normally driven at high frequency of several tens kHz, and hence a harmonic wave of several hundred kHz is superimposed on the signal detected by the tube current detection circuit. Therefore, a magnetic field generated by a wiring section connecting the cold cathode tube and the tube current detection circuit becomes larger to cause a problem of an increase in electromagnetic interference (EMI) level.

The present invention has been made to solve the above-mentioned problem, and therefore it is an object of the present invention to provide an inverter circuit, a backlight device, and a display device which are capable of suppressing the increase in EMI level.

### Means for solving the Problem

In order to achieve the above-mentioned object, according to a first aspect of the present invention, there is provided an inverter circuit for driving a fluorescent lamp, including: a drive circuit for outputting a pulse signal for driving the fluorescent lamp; a transformer for outputting a drive signal corresponding to the pulse signal to the fluorescent lamp, the transformer including a primary winding connected to the drive circuit and a secondary winding having one end connected to the fluorescent lamp; a detection control circuit for detecting a first signal corresponding to the drive signal supplied to the fluorescent lamp; a first wiring line connecting another end of the secondary winding of the transformer and the detection control circuit, through which the first signal flows; and a second wiring line provided together with the first wiring line so that magnetic fields generated are cancelled out each other or made smooth, in which the drive circuit controls, based on the first signal detected by the detection control circuit, the pulse signal to be output to the transformer.

In the inverter circuit according to the first aspect, as described above, the second wiring line is provided together with the first wiring line so that magnetic fields generated may be cancelled out each other or made smooth, and hence the magnetic fields generated by the first wiring line and the second wiring line may be cancelled out each other or made smooth (constant), to thereby suppress an increase in EMI level even when the magnetic field generated by the first wiring line is large.

Further, in the inverter circuit according to the first aspect, as described above, the drive circuit is configured to control, based on the first signal detected by the detection control circuit, the pulse signal to be output to the transformer, to thereby control the drive signal supplied to the fluorescent lamp. Therefore, for example, constant brightness of the fluorescent lamp may be obtained.

In the above-mentioned inverter circuit according to the first aspect, the first wiring line and the second wiring line are preferred to have a twisted pair configuration, and, in the second wiring line, a second signal is preferred to flow, which is in opposite phase to the first signal flowing through the first wiring line. With this configuration, the magnetic fields generated by the first wiring line and the second wiring line may easily be cancelled out each other, and hence the EMI level may be reduced with ease. Besides, because of the twisted pair configuration of the first wiring line and the second wiring line, energy generated by the first wiring line and the second wiring line other than the magnetic fields may also be cancelled out each other, to thereby further reduce the EMI level.

In the above-mentioned inverter circuit in which the first wiring line and the second wiring line have the twisted pair configuration, the second wiring line is preferred to be formed as a GND wiring line. With this configuration, when the first signal flows through the first wiring line, the second signal in opposite phase to the first signal flows through the second wiring line. Therefore, the magnetic fields generated by the first wiring line and the second wiring line may easily be cancelled out each other.

In the above-mentioned inverter circuit in which the second wiring line is formed as the GND wiring line, the second wiring line is preferred to be connected to a GND terminal of the detection control circuit. With this configuration, the second wiring line may be formed as the GND wiring line with ease. Besides, because the second wiring line is connected to the GND terminal of the detection control circuit, the twisted pair configuration of the first wiring line and the second wiring line may be formed longer, to thereby reduce the EMI level effectively.

In the above-mentioned inverter circuit according to the first aspect, the fluorescent lamp is preferred to include a pair of fluorescent lamps, the transformer is preferred to include a pair of transformers connected to the pair of fluorescent lamps, respectively, the first wiring line is preferred to be connected to one of the pair of transformers and the detection control circuit, the second wiring line is preferred to be connected to another of the pair of transformers and the detection control circuit, and, in the second wiring line, a third signal is preferred to flow, which is in opposite polarity to the first signal flowing through the first wiring line. With this configuration, the magnetic fields generated by the first wiring line and the second wiring line may easily be cancelled out each other, to thereby reduce the EMI level with ease.

The above-mentioned inverter circuit in which the third signal flows through the second wiring line is preferred to further include: a first half-wave rectifier circuit provided to the first wiring line; and a second half-wave rectifier circuit provided to the second wiring line in an opposite direction to the first half-wave rectifier circuit. This configuration makes it easy to allow the third signal in opposite polarity to the first signal flowing through the first wiring line to flow through the second wiring line. Besides, because the first half-wave rectifier circuit is provided to the first wiring line and the second half-wave rectifier circuit is provided to the second wiring line, the time (quantity) during which the first signal flows through the first wiring line and the time (quantity) during which the second signal flows through the second wiring line may be reduced, to thereby further reduce the EMI level.

In the above-mentioned inverter circuit in which the first half-wave rectifier circuit is provided to the first wiring line and the second half-wave rectifier circuit is provide to the second wiring line, the first half-wave rectifier circuit and the second half-wave rectifier circuit are preferred to be provided in sections of the first wiring line and the second wiring line on sides of the pair of transformers, respectively. With this configuration, the first wiring line and the second wiring line maybe formed to have longer sections for canceling out the magnetic fields generated, to thereby reduce the EMI level effectively.

In the above-mentioned inverter circuit according to the first aspect, the fluorescent lamp is preferred to include a pair of fluorescent lamps, the transformer is preferred to include a pair of transformers connected to the pair of fluorescent lamps, respectively, the first wiring line is preferred to be connected to one of the pair of transformers and the detection control circuit, the second wiring line is preferred to be connected to another of the pair of transformers and the detection control circuit, and, in the second wiring line, a fourth signal is preferred to flow, which is inverted with respect to the first signal flowing through the first wiring line. With this configuration, part of the first signal flowing through the first wiring line having large (small) amplitude and part of the fourth signal flowing through the second wiring line having small (large) amplitude may be superimposed on each other. In other words, it is possible to suppress the superimposition of the part of the first signal flowing through the first wiring line having the large amplitude and the part of the fourth signal flowing through the second wiring line having the large amplitude. As a result, the sum of the magnetic fields generated by the first wiring line and the second wiring line may be made smooth (constant) with ease, to thereby suppress the increase in EMI level with ease.

The above-mentioned inverter circuit in which the fourth signal flows through the second wiring line is preferred to further include an inverting circuit provided to the second wiring line. This configuration makes it easy to allow the fourth signal inverted with respect to the first signal flowing through the first wiring line to flow through the second wiring line, and hence the sum of the magnetic fields generated by the first wiring line and the second wiring line may be made smooth (constant) with more ease.

The above-mentioned inverter circuit in which the inverting circuit is provided to the second wiring line is preferred to further include: a third half-wave rectifier circuit provided to the first wiring line; and a fourth half-wave rectifier circuit provided to the second wiring line in the same direction as the third half-wave rectifier circuit. This configuration makes it easier to allow the fourth signal inverted with respect to the first signal flowing through the first wiring line to flow through the second wiring line.

In the above-mentioned inverter circuit in which the inverting circuit is provided to the second wiring line, the inverting circuit is preferred to be provided in a section of the second wiring line on a side of the another of the pair of transformers. With this configuration, the first wiring line and the second wiring line may be formed to have longer sections for making smooth (constant) the sum of the magnetic fields generated, to thereby reduce the EMI level effectively.

In the above-mentioned inverter circuit in which the fluorescent lamp includes the pair of fluorescent lamps, the first wiring line and the second wiring line are preferred to be arranged, at least in part, substantially in parallel to each other. With this configuration, energy generated by at least a part of the first wiring line and the second wiring line other than the magnetic fields may also be cancelled out each other or made smooth (constant), to thereby further suppress the increase in EMI level.

In the above-mentioned inverter circuit according to the first aspect, the detection control circuit is preferred to output an adjusting pulse signal to the drive circuit based on the detected first signal, and the drive circuit is preferred to control the pulse signal to be output to the transformer based on the adjusting pulse signal. With this configuration, the drive circuit is easily configured to control the pulse signal to be output to the transformer based on the first signal detected by the detection control circuit. Therefore, the drive signal supplied to the fluorescent lamp may easily be controlled to obtain, for example, constant brightness of the fluorescent lamp.

A backlight device according to a second aspect of the present invention includes: the inverter circuit described above; and a fluorescent lamp driven by the inverter circuit. With this configuration, a backlight device capable of suppressing the increase in EMI level may be obtained.

A display device according to a third aspect of the present invention includes: the above-mentioned backlight device; and a display panel illuminated by the backlight device. With this configuration, a display device capable of suppressing the increase in EMI level may be obtained.

### Effects of the Invention

As described above, according to the present invention, it is possible to easily obtain the inverter circuit, the backlight device, and the display device which are capable of suppressing the increase in EMI level.

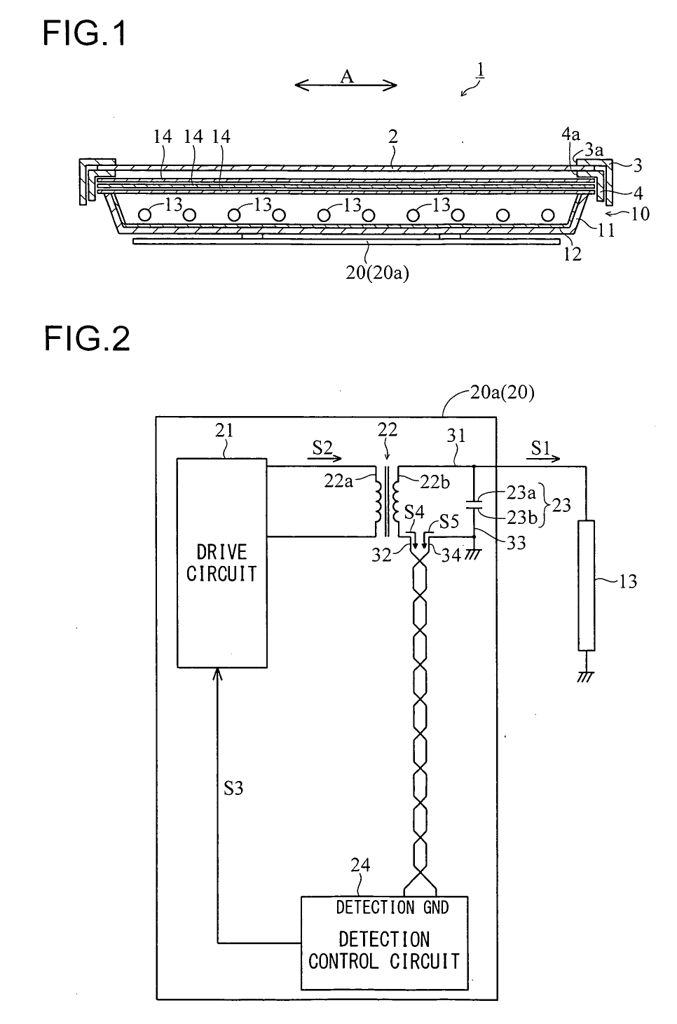

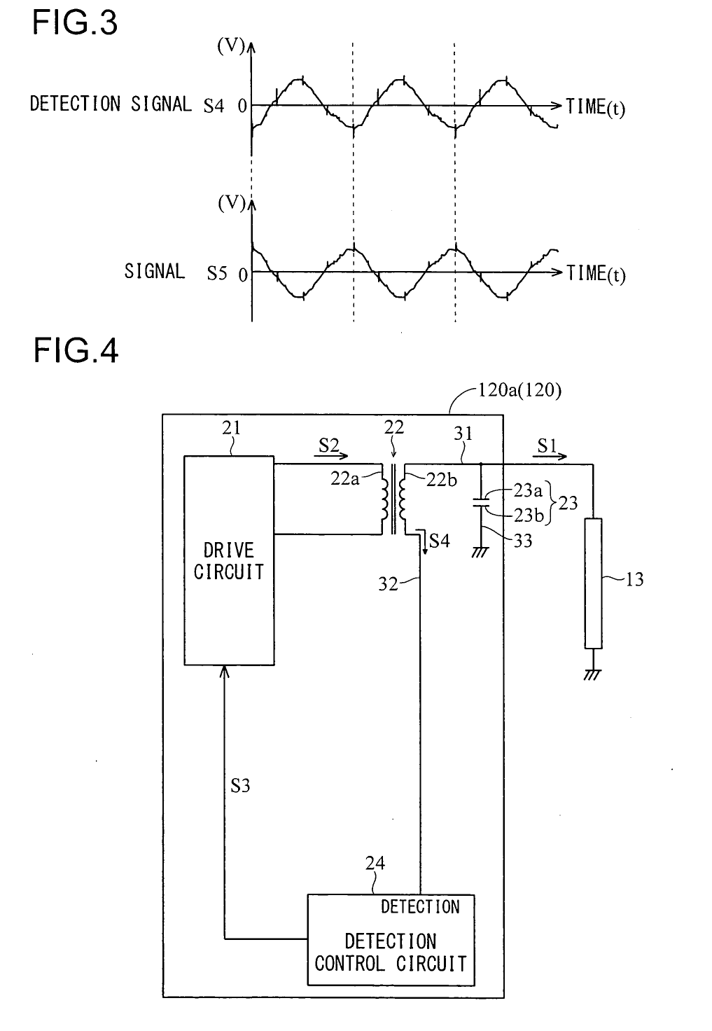

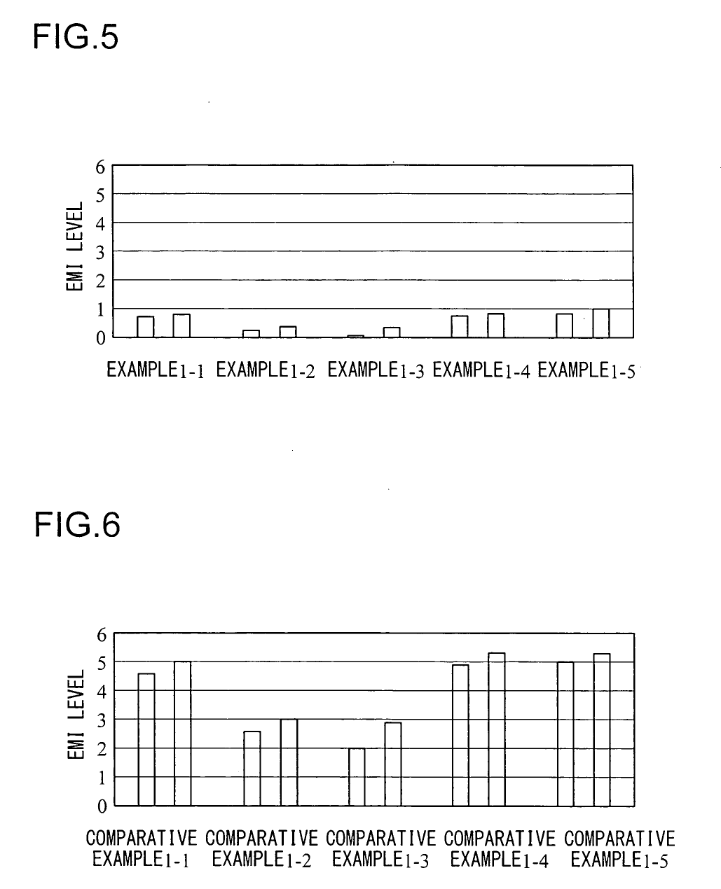

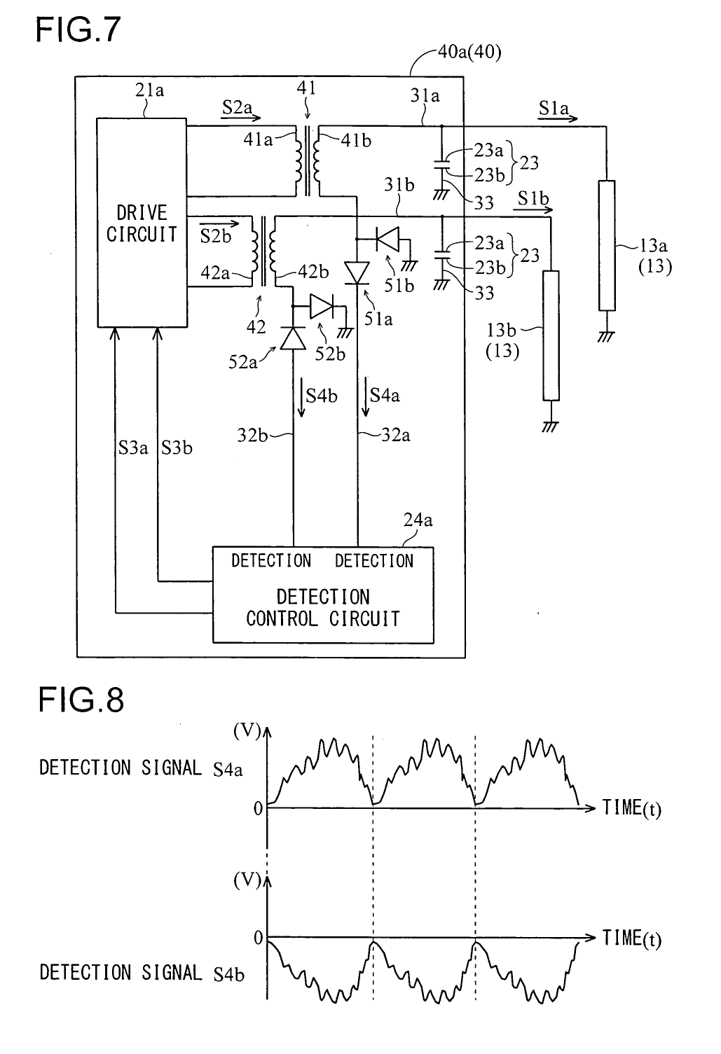

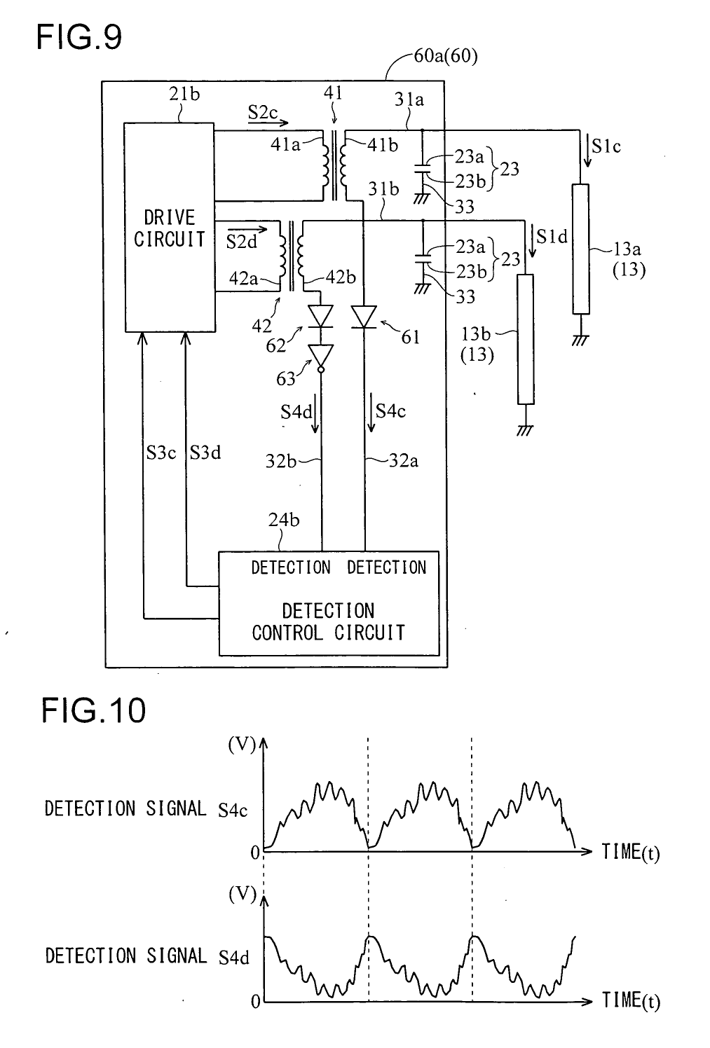

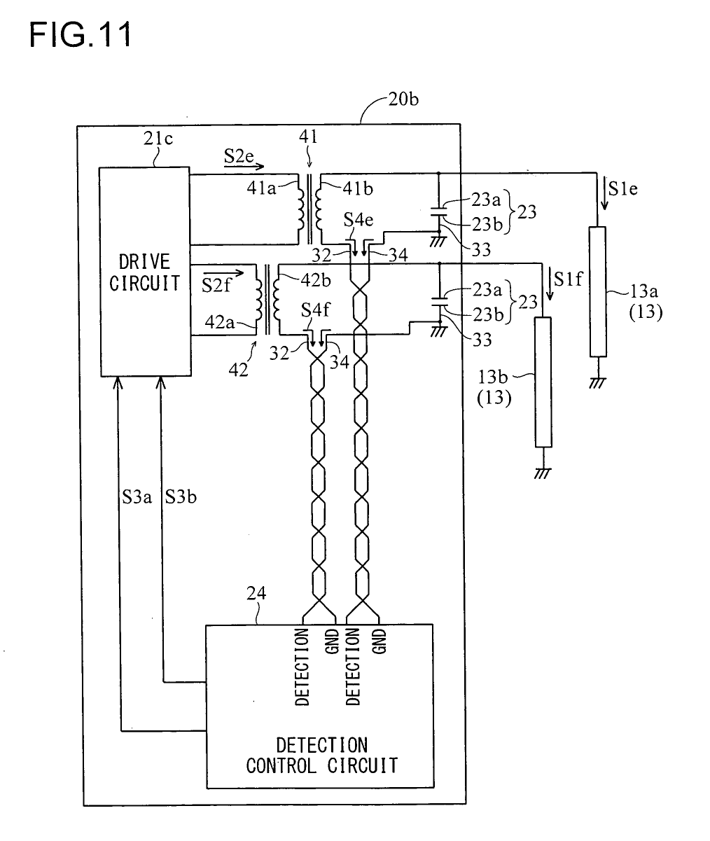

### BRIEF DESCRIPTION OF THE DRAWINGS

[FIG. 1] A cross-sectional view illustrating structure of a liquid crystal display device including an inverter circuit board (inverter circuit) according to a first embodiment of the present invention.

[FIG. 2] A block diagram illustrating a circuit configuration of the inverter circuit board (inverter circuit) according to the first embodiment illustrated in FIG. 1.

[FIG. 3] A diagram illustrating voltage waveforms of respective signals flowing through wiring lines 32 and 34 of the inverter circuit board (inverter circuit) according to the first embodiment illustrated in FIG. 2.

[FIG. 4] A block diagram illustrating a configuration of an inverter circuit board (inverter circuit) according to Comparative Examples of the first embodiment illustrated in FIG. 1.

[FIG. 5] A graph illustrating EMI level of an inverter circuit according to Examples of the first embodiment illustrated in FIG. 1.

[FIG. 6] A graph illustrating EMI level of the inverter circuit according to Comparative Examples of the first embodiment illustrated in FIG. 1.

[FIG. 7] A block diagram illustrating a configuration of an inverter circuit board (inverter circuit) and a cold cathode fluorescent lamp according to a second embodiment of the present invention.

[FIG. 8] A diagram illustrating voltage waveforms of respective signals flowing through wiring lines 32a and 32b of the inverter circuit board (inverter circuit) according to the second embodiment illustrated in FIG. 7.

[FIG. 9] A block diagram illustrating a configuration of an inverter circuit board (inverter circuit) and a cold cathode fluorescent lamp according to a third embodiment of the present invention.

[FIG. 10] A diagram illustrating voltage waveforms of respective signals flowing through wiring lines 32a and 32b of the inverter circuit board (inverter circuit) according to the third embodiment illustrated in FIG. 9.

[FIG. 11] A block diagram illustrating a configuration of an inverter circuit and a cold cathode fluorescent lamp according to a modified example of the present invention.

### DESCRIPTION OF SYMBOLS

1 liquid crystal display device (display device)

2 liquid crystal display panel (display panel)

10 backlight device

13, 13a, 13b cold cathode fluorescent lamp

20a, 20b, 40a, 60a inverter circuit

21, 21a, 21b, 21c drive circuit

22 transformer

22a, 41a, 42a primary winding

22b, 41b, 42b secondary winding

24, 24a, 24b detection control circuit

32, 32a wiring line (first wiring line)

32b, 34 wiring line (second wiring line)

41 transformer (one of pair of transformers)

42 transformer (another of pair of transformers)

51a diode (first half-wave rectifier circuit)

52a diode (second half-wave rectifier circuit)

61 diode (third half-wave rectifier circuit)

62 diode (fourth half-wave rectifier circuit)

63 inverting circuit

S1, S1a, S1b, S1c, S1d, S1e, S1f drive signal

S2, S2a, S2b, S2c, S2d, S2e, S2f pulse signal

S3, S3a, S3c current adjusting pulse signal (adjusting pulse signal)

S4, S4a, S4c, S4e, S4f detection signal (first signal)

S4b detection signal (third signal)

S4d detection signal (fourth signal)

S5 signal (second signal)

### BEST MODES FOR CARRYING OUT THE INVENTION

### First Embodiment

Now, referring to FIGS. 1 to 3, description is given of structure of a liquid crystal display device 1 including an inverter circuit board 20 (inverter circuit 20a) according to a first embodiment of the present invention. Note that, the liquid crystal display device 1 is used as a display device of a liquid crystal television receiver (not shown) or the like.

As illustrated in FIG. 1, the liquid crystal display device 1 including the inverter circuit board 20 (inverter circuit 20a) according to the first embodiment of the present invention includes a liquid crystal display panel 2, frames 3 and 4 holding the liquid crystal display panel 2 in a sandwiched manner, and a direct-type backlight device 10 disposed on a rear surface side of the liquid crystal display panel 2. Note that, the liquid crystal display device 1 is an example of a “display device” of the present invention, and the liquid crystal display panel 2 is an example of a “display panel” of the present invention.

The liquid crystal display panel 2 includes two glass substrates sandwiching a liquid crystal layer (not shown) therebetween. The liquid crystal display panel 2 is illuminated by the backlight device 10 to serve as the display panel.

The frames 3 and 4 are respectively formed of metal plates in which openings 3a and 4a are formed in a portion corresponding to a display area of the liquid crystal display panel 2. The frames 3 and 4 are fixed to the front of the backlight device 10.

The backlight device 10 includes a chassis 11 formed, of a metal plate, a reflection sheet 12 disposed on a front surface side of the chassis 11, a plurality of cold cathode fluorescent lamps 13, a plurality of optical sheets 14, and the inverter circuit board 20 attached to the rear surface of the chassis 11. Note that, the cold cathode fluorescent lamp 13 is an example of a “fluorescent lamp” of the present invention.

The reflection sheet 12 is fixed onto the front surface (inner surface) of the chassis 11. In other words, the reflection sheet 12 is disposed on the back side of the cold cathode fluorescent lamps 13 to have a function of reflecting light which is emitted backward from the cold cathode fluorescent lamps 13, to the front side (liquid crystal display panel 2 side).

The cold cathode fluorescent lamp 13 is formed of a straight fluorescent tube. The plurality of cold cathode fluorescent lamps 13 are arranged in parallel to one another along the direction of A at predetermined intervals. Note that, as the cold cathode fluorescent lamp 13, for example, a U-shaped or C-shaped fluorescent tube may be used instead of the straight fluorescent tube.

The cold cathode fluorescent lamp 13 is electrically connected to the inverter circuit board 20 and emits light when supplied with an alternating high voltage drive signal S1 (see FIG. 2) from the inverter circuit board 20.

The plurality of optical sheets 14 include diffusion sheets for diffusing light, lens sheets for condensing light forward, and the like.

Here, according to the first embodiment, as illustrated in FIG. 2, the inverter circuit board 20 is provided with a drive circuit 21, a transformer 22 having a primary winding 22a electrically connected to the drive circuit 21, a resonant capacitor 23 electrically connected to one end (high-voltage side) of a secondary winding 22b of the transformer 22, and a detection control circuit 24 electrically connected to another end (low-voltage side) of the secondary winding 22b of the transformer 22.

The drive circuit 21, the transformer 22, the resonant capacitor 23, the detection control circuit 24, wiring lines 31 to 34 described later, and the like together form the inverter circuit 20a for driving the cold cathode fluorescent lamp 13. Note that, the transformer 22 is an example of a “transformer” of the present invention. Further, for simplification of the drawing, FIG. 2 illustrates a single cold cathode fluorescent lamp 13, a single transformer 22, and a single resonant capacitor 23.

The drive circuit 21 has a function of outputting a pulse signal S2 having a predetermined frequency to the transformer 22 so as to allow the cold cathode fluorescent lamp 13 to emit light. Further, as described later, the drive circuit 21 adjusts (controls) a pulse width of the pulse signal S2, which is to be output to the transformer 22, based on a current adjusting pulse signal S3 supplied from the detection control circuit 24. Accordingly, it is possible to adjust (control) a current supplied to the cold cathode fluorescent lamp 13, to thereby obtain constant brightness of the cold cathode fluorescent lamp 13. Note that, the drive circuit 21 and the detection control circuit 24 may be built in a single integrated circuit (IC) or separate ICs independent of each other. Further, the current adjusting pulse signal S3 is an example of an “adjusting pulse signal” of the present invention.

The transformer 22 is configured such that the primary winding 22a and the secondary winding 22b have a predetermined turns ratio. The transformer 22 has a function of converting the pulse signal S2 supplied to the primary winding 22a into an alternating high voltage for driving the cold cathode fluorescent lamp 13. In other words, the transformer 22 has a function of outputting the drive signal S1 corresponding to the pulse signal S2 to the cold cathode fluorescent lamp 13.

The one end of the secondary winding 22b of the transformer 22 is connected to the cold cathode fluorescent lamp 13 via the wiring line 31, and the another end thereof is connected to a detection terminal of the detection control circuit 24 via the wiring line 32. In the wiring line 32, a detection signal S4 flows, which corresponds to the drive signal S1 supplied to the cold cathode fluorescent lamp 13. Note that, the wiring line 32 is an example of a “first wiring line” of the present invention, and the detection signal S4 is an example of a “first signal” of the present invention.

The resonant capacitor 23 forms a resonant circuit together with the secondary winding 22b of the transformer 22. One electrode 23a of the resonant capacitor 23 is connected to the wiring line 31 connecting the transformer 22 and the cold cathode fluorescent lamp 13, and another electrode 23b thereof is connected to GND of the inverter circuit board 20 via the wiring line 33.

Here, according to the first embodiment, one end of the wiring line 34 is connected to the wiring line 33 connecting the another electrode 23b of the resonant capacitor 23 and the GND of the inverter circuit board 20. Another end of the wiring line 34 is connected to a GND terminal of the detection control circuit 24. In other words, the wiring line 34 is formed as a GND wiring line. Note that, the wiring line 34 is an example of a “second wiring line” of the present invention.

Further, according to the first embodiment, the wiring line 32 and the wiring line 34 have a twisted pair configuration. Accordingly, voltage waveforms of respective signals flowing through the wiring lines 32 and 34 are obtained as illustrated in FIG. 3, for example. Specifically, in the wiring line 34, a signal S5 flows, which is in opposite phase to the detection signal S4 flowing through the wiring line 32. Therefore, a magnetic field generated by the wiring line 32 upon the flow of the detection signal S4 and a magnetic field generated by the wiring line 34 upon the flow of the signal S5 are cancelled out each other. Note that, the signal S5 is an example of a “second signal” of the present invention.

As illustrated in FIG. 2, the detection control circuit 24 has a function of detecting the detection signal S4 via the wiring line 32 connected to the another end of the secondary winding 22b of the transformer 22. Based on the detected detection signal S4, the detection control circuit 24 outputs the current adjusting pulse signal S3 to the drive circuit 21. Accordingly, the drive circuit 21 adjusts (controls), based on the current adjusting pulse signal S3, the pulse width of the pulse signal S2 to be output to the transformer 22 so as to obtain constant brightness of the cold cathode fluorescent lamp 13.

According to the first embodiment, as described above, the wiring line 34 is provided together with the wiring line 32 so that the magnetic fields generated may be cancelled out each other, and hence EMI level may be reduced even when the magnetic field generated by the wiring line 32 is large.

Further, according to the first embodiment, based on the detection signal S4 detected by the detection control circuit 24, the drive circuit 21 controls the pulse signal S2 to be output to the transformer 22, to thereby control the drive signal S1 supplied to the cold cathode fluorescent lamp 13 to obtain constant brightness of the cold cathode fluorescent lamp 13.

Still further, according to the first embodiment, the wiring line 32 and the wiring line 34 have the twisted pair configuration so that the signal S5 in opposite phase to the detection signal S4 flowing through the wiring line 32 may flow through the wiring line 34, and hence the magnetic fields generated by the wiring line 32 and the wiring line 34 may easily be cancelled out each other, which makes it easy to reduce the EMI level. Besides, because of the twisted pair configuration of the wiring line 32 and the wiring line 34, energy generated by the wiring line 32 and the wiring line 34 other than the magnetic fields may also be cancelled out each other to further reduce the EMI level.

Yet further, according to the first embodiment, the wiring line 34 is formed as the GND wiring line, and hence when the detection signal S4 flows through the wiring line 32, the signal S5 in opposite phase to the detection signal S4 flows through the wiring line 34. Therefore, the magnetic fields generated by the wiring line 32 and the wiring line 34 may easily be cancelled out each other.

Yet further, according to the first embodiment, the wiring line 34 is connected to the GND terminal of the detection control circuit 24, and hence the twisted pair configuration of the wiring line 32 and the wiring line 34 may be formed longer to reduce the EMI level effectively.

Next, referring to FIGS. 2 and 4 to 6, description is given of comparison experiments conducted for confirming effects of the inverter circuit 20a according to the first embodiment of the present invention.

In the comparison experiments, a noise terminal voltage was measured using five inverter circuits 20a (inverter circuit boards 20) according to Examples 1-1, 1-2, 1-3, 1-4, and 1-5 each corresponding to the first embodiment, and five inverter circuits 120a (inverter circuit boards 120) according to Comparative Examples 1-1, 1-2, 1-3, 1-4, and 1-5. The inverter circuits 20a according to Examples 1-1 to 1-5 (see FIG. 2) were configured similarly to that of the first embodiment. The inverter circuit boards 120 according to Comparative Examples 1-1 to 1-5 were each configured as illustrated in FIG. 4 so that the wiring line 34 (see FIG. 2) was not provided between the wiring line 33 and the detection control circuit 24. Other configurations of the inverter circuit 120a were the same as those of the inverter circuit 20a.

Specifically, under a state in which the drive signal S1 supplied to the cold cathode fluorescent lamp 13 was set to about 33.9 kHz, the noise terminal voltage of the detection terminal of the detection control circuit 24 was measured using an oscilloscope with respect to the inverter circuits 20a and 120a. In this case, for each inverter circuit 20a, the noise terminal voltages of two detection terminals were measured. Similarly, also for each inverter circuit 120a, the noise terminal voltages of two detection terminals were measured.

Then, comparison was made on the EMI level (noise terminal voltage) of about 570 kHz, which was a harmonic wave component with respect to about 33.9 kHz. FIGS. 5 and 6 illustrate the EMI levels of about 570 kHz in the inverter circuits 20a and 120a, respectively. Note that, in FIGS. 5 and 6, the EMI levels are normalized with an allowable value (limit value) set to “6”.

As illustrated in FIGS. 5 and 6, it was found that, compared with the inverter circuits 120a according to Comparative Examples 1-1 to 1-5, the inverter circuits 20a according to Examples 1-1 to 1-5 each had the low EMI levels (noise terminal voltages) of about 570 kHz with little fluctuation. Specifically, according to Examples 1-1 to 1-5, the normalized EMI levels took from about 0 to about 1. According to Comparative Examples 1-1 to 1-5, on the other hand, the normalized EMI levels took from about 2 to about 5.

This is considered to result from the following reason. That is, it is considered that, in each of the inverter circuits 20a according to Examples 1-1 to 1-5, the wiring line 32 and the wiring line 34 had the twisted pair configuration so that the signal S5 in opposite phase to the detection signal S4 flowing through the wiring line 32 could flow through the wiring line 34 and therefore the magnetic fields generated by the wiring line 32 and the wiring line 34 were able to be cancelled out each other.

### Second Embodiment

In this second embodiment, referring to FIGS. 7 and 8, description is given of an example of an inverter circuit board 40 (inverter circuit 40a) in which, unlike the above-mentioned first embodiment, half-wave rectifier circuits (diodes 51a and 52a) are provided to wiring lines 32a and 32b connecting transformers 41 and 42 to a detection control circuit 24a, respectively.

In a backlight device including the inverter circuit board 40 (inverter circuit 40a) according to the second embodiment of the present invention, as illustrated in FIG. 7, the cold cathode fluorescent lamps 13 include a plurality of pairs of cold cathode fluorescent lamps 13a and 13b. Note that, the cold cathode fluorescent lamps 13a and 13b are an example of a “pair of fluorescent lamps” of the present invention. Further, for simplification of the drawing, FIG. 7 illustrates only one pair of cold cathode fluorescent lamps 13a and 13b.

The cold cathode fluorescent lamps 13a and 13b are electrically connected to the inverter circuit board 40 and emit light when supplied with alternating high voltage drive signals S1a and S1b from the inverter circuit board 40, respectively.

According to the second embodiment, the inverter circuit board 40 is provided with a drive circuit 21a, the pair of transformers 41 and 42 electrically connected to the drive circuit 21a, resonant capacitors 23 electrically connected to the transformers 41 and 42, respectively, the detection control circuit 24a electrically connected to the transformers 41 and 42, the diodes 51a and 51b disposed between the transformer 41 and the detection control circuit 24a, and the diodes 52a and 52b disposed between the transformer 42 and the detection control circuit 24a.

The drive circuit 21a, the transformers 41 and 42, the resonant capacitors 23, the detection control circuit 24a, the diodes 51a, 51b, 52a, and 52b, wiring lines 31a, 31b, 32a, and 32b described later, and the like together form the inverter circuit 40a for driving the cold cathode fluorescent lamps 13 (13a and 13b). Note that, the transformer 41 is an example of the “transformer” and “one of a pair of transformers” of the present invention, and the transformer 42 is an example of the “transformer” and “another of the pair of transformers” of the present invention. Further, the diode 51a is an example of a “first half-wave rectifier circuit” of the present invention, and the diode 52a is an example of a “second half-wave rectifier circuit” of the present invention.

The drive circuit 21a has a function of outputting a pulse signal S2a having a predetermined frequency and a pulse signal S2b in opposite phase to the pulse signal S2a to the transformers 41 and 42, respectively. Further, as described later, the drive circuit 21a adjusts (controls), based on current adjusting pulse signals S3a and S3b supplied from the detection control circuit 24a, a pulse width of each of the pulse signals S2a and S2b, which are to be output to the transformers 41 and 42, respectively. Note that, the current adjusting pulse signal S3a is an example of the “adjusting pulse signal” of the present invention.

A primary winding 41a of the transformer 41 and a primary winding 42a of the transformer 42 are electrically connected to the drive circuit 21a.

One end (high-voltage side) of a secondary winding 41b of the transformer 41 is connected to the cold cathode fluorescent lamp 13a via the wiring line 31a, and another end (low-voltage side) thereof is connected to a detection terminal of the detection control circuit 24a via the wiring line 32a. Further, one end (high-voltage side) of a secondary winding 42b of the transformer 42 is connected to the cold cathode fluorescent lamp 13b via the wiring line 31b, and another end (low-voltage side) thereof is connected to a detection terminal of the detection control circuit 24a via the wiring line 32b. Note that, the wiring line 32a is an example of the “first wiring line” of the present invention, and the wiring line 32b is an example of the “second wiring line” of the present invention.

In the wiring line 32a, a detection signal S4a flows, which corresponds to the drive signal S1a supplied to the cold cathode fluorescent lamp 13a, and in the wiring line 32b, a detection signal S4b flows, which corresponds to the drive signal S1b supplied to the cold cathode fluorescent lamp 13b. Note that, the detection signal S4a is an example of the “first signal” of the present invention, and the detection signal S4b is an example of a “third signal” of the present invention.

Here, according to the second embodiment, the diode 51a is provided on the wiring line 32a connecting the transformer 41 and the detection control circuit 24a. The diode 51a is provided such that an anode thereof is on the transformer 41 side. Further, the diode 51b is provided to connect the wiring line 32a and GND of the inverter circuit board 40. The diode 51b is provided such that an anode thereof is connected to the GND of the inverter circuit board 40.

Further, according to the second embodiment, the diode 52a is provided on the wiring line 32b connecting the transformer 42 and the detection control circuit 24a. Unlike the diode 51a, the diode 52a is provided such that an anode thereof is on the detection control circuit 24a side. Further, the diode 52b is provided to connect the wiring line 32b and the GND of the inverter circuit board 40. Unlike the diode 51b, the diode 52b is provided such that an anode thereof is connected to the wiring line 32b. In other words, to the wiring line 32b, the diodes 52a and 52b are provided in the opposite directions to the diodes 51a and 51b provided to the wiring line 32a, respectively.

Accordingly, voltage waveforms of the respective signals flowing through the wiring lines 32a and 32b are obtained as illustrated in FIG. 8. Specifically, in the wiring line 32b, the detection signal S4b flows, which is in opposite polarity to the detection signal S4a flowing through the wiring line 32a. Therefore, a magnetic field generated by the wiring line 32a upon the flow of the detection signal S4a and a magnetic field generated by the wiring line 32b upon the flow of the detection signal S4b are cancelled out each other.

As illustrated in FIG. 7, the section of the wiring line 32a from a part in which the diodes 51a and 51b are provided to a part connected to the detection control circuit 24a and the section of the wiring line 32b from a part in which the diodes 52a and 52b are provided to a part connected to the detection control circuit 24a are arranged substantially in parallel to each other.

The diodes 51a and 51b are provided in the section of the wiring line 32a on the transformer 41 side. The diodes 52a and 52b are provided in the section of the wiring line 32b on the transformer 42 side.

The detection control circuit 24a has a function of detecting the detection signal S4a via the wiring line 32a connected to the another end of the secondary winding 41b of the transformer 41. Then, based on the detected detection signal S4a, the detection control circuit 24a outputs the current adjusting pulse signal S3a to the drive circuit 21a.

Further, the detection control circuit 24a has a function of detecting the detection signal S4b via the wiring line 32b connected to the another end of the secondary winding 42b of the transformer 42. Then, based on the detected detection signal S4b, the detection control circuit 24a outputs the current adjusting pulse signal S3b to the drive circuit 21a.

Accordingly, the drive circuit 21a adjusts (controls), based on the current adjusting pulse signal S3a, the pulse width of the pulse signal S2a to be output to the transformer 41 so as to obtain constant brightness of the cold cathode fluorescent lamp 13a. Further, the drive circuit 21a adjusts (controls), based on the current adjusting pulse signal S3b, the pulse width of the pulse signal S2b to be output to the transformer 42 so as to obtain constant brightness of the cold cathode fluorescent lamp 13b.

Other configurations of the second embodiment are the same as those of the above-mentioned first embodiment.

Note that, if EMI levels (noise terminal voltages) of the inverter circuit 40a according to the second embodiment are measured similarly to the above-mentioned first embodiment, in the inverter circuit 40a of the second embodiment, the EMI levels (noise terminal voltages) are expected to be low with little fluctuation as in the above-mentioned first embodiment because the magnetic fields generated by the wiring line 32a and the wiring line 32b are cancelled out each other.

According to the second embodiment, as described above, the detection signal S4b in opposite polarity to the detection signal S4a flowing through the wiring line 32a flows through the wiring line 32b, and hence the magnetic fields generated by the wiring line 32a and the wiring line 32b may be cancelled out each other, to thereby reduce the EMI level.

Further, according to the second embodiment, the diodes 51a and 51b are provided to the wiring line 32a, and the diodes 52a and 52b are provided to the wiring line 32b in the opposite directions to the diodes 51a and 51b, respectively, which makes it easy to allow the detection signal S4b in opposite polarity to the detection signal S4a flowing through the wiring line 32a to flow through the wiring line 32b. Besides, because the diode 51a is provided to the wiring line 32a and the diode 52a is provided to the wiring line 32b, the time (quantity) during which the detection signal S4a flows through the wiring line 32a and the time (quantity) during which the detection signal S4b flows through the wiring line 32b may be reduced to further reduce the EMI level.

Still further, according to the second embodiment, the diode 51a and the diode 52a are provided in the section of the wiring line 32a on the transformer 41 side and the section of the wiring line 32b on the transformer 42 side, respectively, and hence the wiring line 32a and the wiring line 32b may be formed to have longer sections for canceling out the magnetic fields generated, to thereby reduce the EMI level effectively.

Yet further, according to the second embodiment, the section of the wiring line 32a from the part in which the diodes 51a and 51b are provided to the part connected to the detection control circuit 24a and the section of the wiring line 32b from the part in which the diodes 52a and 52b are provided to the part connected to the detection control circuit 24a are arranged substantially in parallel to each other, and hence energy generated by the wiring line 32a and the wiring line 32b other than the magnetic fields may also be cancelled out each other to further reduce the EMI level.

Note that, other effects of the second embodiment are the same as those of the above-mentioned first embodiment.

### Third Embodiment

In this third embodiment, referring to FIGS. 9 and 10, description is given of an example of an inverter circuit board 60 (inverter circuit 60a) in which, unlike the above-mentioned second embodiment, an inverting circuit 63 is provided to the wiring line 32b connecting the transformer 42 and a detection control circuit 24b.

According to the third embodiment, as illustrated in FIG. 9, the cold cathode fluorescent lamps 13a and 13b are electrically connected to the inverter circuit board 60 and emit light when supplied with alternating high voltage drive signals S1c and S1d from the inverter circuit board 60, respectively.

The inverter circuit board 60 (inverter circuit 60a) is provided with a drive circuit 21b, the pair of transformers 41 and 42, the resonant capacitors 23, the detection control circuit 24b electrically connected to the transformers 41 and 42, a diode 61 disposed between the transformer 41 and the detection control circuit 24b, and a diode 62 and the inverting circuit 63 which are disposed between the transformer 42 and the detection control circuit 24b.

The drive circuit 21b, the transformers 41 and 42, the resonant capacitors 23, the detection control circuit 24b, the diodes 61 and 62, the inverting circuit 63, the wiring lines 31a, 31b, 32a, and 32b, and the like together form the inverter circuit 60a for driving the cold cathode fluorescent lamps 13 (13a and 13b). Note that, the diode 61 is an example of a “third half-wave rectifier circuit” of the present invention, and the diode 62 is an example of a “fourth half-wave rectifier circuit” of the present invention.

The drive circuit 21b has a function of outputting a pulse signal S2c having a predetermined frequency and a pulse signal S2d in phase with the pulse signal S2c to the transformers 41 and 42, respectively. Further, as described later, the drive circuit 21b adjusts (controls), based on current adjusting pulse signals S3c and S3d supplied from the detection control circuit 24b, a pulse width of each of the pulse signals S2c and S2d, which are output to the transformers 41 and 42, respectively. Note that, the current adjusting pulse signal S3c is an example of the “adjusting pulse signal” of the present invention.

Here, according to the third embodiment, the diode 61 is provided on the wiring line 32a connecting the transformer 41 and the detection control circuit 24b. The diode 61 is provided such that an anode thereof is on the transformer 41 side. Further, the diode 62 and the inverting circuit 63 are provided on the wiring line 32b connecting the transformer 42 and the detection control circuit 24b. The diode 62 is provided such that an anode thereof is on the transformer 42 side. In other words, the diode 62 is provided to the wiring line 32b in the same direction as the diode 61 provided to the wiring line 32a.

Accordingly, voltage waveforms of respective signals flowing through the wiring lines 32a and 32b are obtained as illustrated in FIG. 10. Specifically, in the wiring line 32b, a detection signal S4d flows, which is inverted with respect to a detection signal S4c flowing through the wiring line 32a. Therefore, part of the detection signal S4c flowing through the wiring line 32a having large (small) amplitude and part of the detection signal S4d flowing through the wiring line 32b having small (large) amplitude may be superimposed on each other. In other words, it is possible to suppress the superimposition of the part of the detection signal S4c flowing through the wiring line 32a having the large amplitude and the part of the detection signal S4d flowing through the wiring line 32b having the large amplitude. As a result, the sum of the magnetic field generated by the wiring line 32a upon the flow of the detection signal S4c and the magnetic field generated by the wiring line 32b upon the flow of the detection signal S4d is made smooth (constant). Note that, the detection signal S4c is an example of the “first signal” of the present invention, and the detection signal S4d is an example of a “fourth signal” of the present invention.

As illustrated in FIG. 9, the section of the wiring line 32a from a part in which the diode 61 is provided to a part connected to the detection control circuit 24b and the section of the wiring line 32b from a part in which the diode 62 and the inverting circuit 63 are provided to a part connected to the detection control circuit 24b are arranged substantially in parallel to each other.

The diode 61 is provided in the section of the wiring line 32a on the transformer 41 side. The diode 62 and the inverting circuit 63 are provided in the section of the wiring line 32b on the transformer 42 side.

The detection control circuit 24b has a function of detecting the detection signal S4c via the wiring line 32a connected to the another end of the secondary winding 41b of the transformer 41. Then, based on the detected detection signal S4c, the detection control circuit 24b outputs the current adjusting pulse signal S3c to the drive circuit 21b.

Further, the detection control circuit 24b has a function of detecting the detection signal S4d via the wiring line 32b connected to the another end of the secondary winding 42b of the transformer 42. Then, based on the detected detection signal S4d, the detection control circuit 24b outputs the current adjusting pulse signal S3d to the drive circuit 21b.

Other configurations of the third embodiment are the same as those of the above-mentioned second embodiment.

Note that, if EMI levels (noise terminal voltages) of the inverter circuit 60a according to the third embodiment are measured similarly to the above-mentioned first and second embodiments, in the inverter circuit 60a of the third embodiment, the EMI levels (noise terminal voltages) are expected to be low with little fluctuation because the sum of the magnetic fields generated by the wiring line 32a and the wiring line 32b is made smooth (constant).

According to the third embodiment, as described above, the detection signal S4d inverted with respect to the detection signal S4c flowing through the wiring line 32a flows through the wiring line 32b, and hence the sum of the magnetic fields generated by the wiring line 32a and the wiring line 32b may be made smooth (constant), to thereby suppress the increase in EMI level.

Further, according to the third embodiment, the inverting circuit 63 is provided to the wiring line 32b to make it easy to allow the detection signal S4d inverted with respect to the detection signal S4c flowing through the wiring line 32a to flow through the wiring line 32b. Therefore, the sum of the magnetic fields generated by the wiring line 32a and the wiring line 32b may be made smooth (constant) with ease.

Still further, according to the third embodiment, the diode 61 is provided to the wiring line 32a and the diode 62 is provided to the wiring line 32b in the same direction as the diode 61, to thereby make it easier to allow the detection signal S4d inverted with respect to the detection signal S4c flowing through the wiring line 32a to flow through the wiring line 32b.

Yet further, according to the third embodiment, the diode 61 is disposed in the section of the wiring line 32a on the transformer 41 side, and the diode 62 and the inverting circuit 63 are disposed in the section of the wiring line 32b on the transformer 42 side, and hence the wiring line 32a and the wiring line 32b may be formed to have longer sections for making smooth (constant) the sum of the magnetic fields generated, to thereby reduce the EMI level effectively.

Other effects of the third embodiment are the same as those of the above-mentioned second embodiment.

Note that, the embodiments disclosed herein should be regarded as being exemplary, not limiting, in all respects. The scope of the present invention is defined by the scope of claims rather than the above description of the embodiments, and encompasses all such modifications within the meaning and scope equivalent to the scope of claims.

For example, the above-mentioned embodiments have exemplified the case of applying the display panel and the display device to the liquid crystal display panel and the liquid crystal display device, respectively, but the present invention is not limited thereto and may also be applied to other display panels than the liquid crystal display panel and other display devices than the liquid crystal display device.

Further, the above-mentioned embodiments have exemplified the case of using the cold cathode fluorescent lamp as an example of the fluorescent lamp, but the present invention is not limited thereto and applicable also to other fluorescent lamps than the cold cathode fluorescent lamp.

Still further, the above-mentioned first embodiment has described only the configuration in which the signal S5 in opposite phase to the detection signal S4 flowing through the wiring line 32 flows through the wiring line 34, but the present invention is not limited thereto and may employ such a configuration as an inverter circuit 20b according to a modified example of the present invention illustrated in FIG. 11. Specifically, the transformers 41 and 42 are provided, corresponding to the pair of cold cathode fluorescent lamps 13a and 13b, respectively, and the wiring lines 32 are connected to the another end of the secondary winding 41b of the transformer 41 and the another end of the secondary winding 42b of the transformer 42, respectively. Then, a drive circuit 21c is configured to output a pulse signal S2e to the transformer 41 and output a pulse signal S2f in opposite phase to the pulse signal S2e to the transformer 42. Accordingly, a drive signal S1e is supplied to the cold cathode fluorescent lamp 13a and a drive signal S1f is supplied to the cold cathode fluorescent lamp 13b. Further, a detection signal S4e flows through the wiring line 32 connected to the transformer 41, and a detection signal S4f in opposite phase to the detection signal S4e flows through the wiring line 32 connected to the transformer 42. With this configuration, the magnetic fields generated by the wiring line 32 connected to the transformer 41 and the wiring line 32 connected to the transformer 42 may be cancelled out each other to further reduce the EMI level.

Yet further, the above-mentioned second and third embodiments have exemplified the wiring lines 32a and 32b, part of which are arranged substantially in parallel to each other, but the present invention is not limited thereto and the wiring lines 32a and 32b need not be arranged substantially in parallel to each other.

1. An inverter circuit for driving a fluorescent lamp, comprising:
a drive circuit for outputting a pulse signal for driving the fluorescent lamp;
a transformer for outputting a drive signal corresponding to the pulse signal to the fluorescent lamp, the transformer including a primary winding connected to the drive circuit and a secondary winding having one end connected to the fluorescent lamp;
a detection control circuit for detecting a first signal corresponding to the drive signal supplied to the fluorescent lamp;
a first wiring line connecting another end of the secondary winding of the transformer and the detection control circuit, through which the first signal flows; and
a second wiring line provided together with the first wiring line so that magnetic fields generated are cancelled out each other or made smooth,
wherein the drive circuit controls, based on the first signal detected by the detection control circuit, the pulse signal to be output to the transformer.

2. An inverter circuit according to claim 1,
wherein the first wiring line and the second wiring line have a twisted pair configuration, and
wherein, in the second wiring line, a second signal flows, which is in opposite phase to the first signal flowing through the first wiring line.

3. An inverter circuit according to claim 2, wherein the second wiring line comprises a GND wiring line.

4. An inverter circuit according to claim 3, wherein the second wiring line is connected to a GND terminal of the detection control circuit.

5. An inverter circuit according to claim 1,
wherein the fluorescent lamp comprises a pair of fluorescent lamps,
wherein the transformer comprises a pair of transformers connected to the pair of fluorescent lamps, respectively,
wherein the first wiring line is connected to one of the pair of transformers and the detection control circuit,
wherein the second wiring line is connected to another of the pair of transformers and the detection control circuit, and
wherein, in the second wiring line, a third signal flows, which is in opposite polarity to the first signal flowing through the first wiring line.

6. An inverter circuit according to claim 5, further comprising:
a first half-wave rectifier circuit provided to the first wiring line; and
a second half-wave rectifier circuit provided to the second wiring line in an opposite direction to the first half-wave rectifier circuit.

7. An inverter circuit according to claim 6, wherein the first half-wave rectifier circuit and the second half-wave rectifier circuit are provided in sections of the first wiring line and the second wiring line on sides of the pair of transformers, respectively.

8. An inverter circuit according to claim 1,
wherein the fluorescent lamp comprises a pair of fluorescent lamps,
wherein the transformer comprises a pair of transformers connected to the pair of fluorescent lamps, respectively,
wherein the first wiring line is connected to one of the pair of transformers and the detection control circuit,
wherein the second wiring line is connected to another of the pair of transformers and the detection control circuit, and
wherein, in the second wiring line, a fourth signal flows, which is inverted with respect to the first signal flowing through the first wiring line.

9. An inverter circuit according to claim 8, further comprising an inverting circuit provided to the second wiring line.

10. An inverter circuit according to claim 9, further comprising:
a third half-wave rectifier circuit provided to the first wiring line; and
a fourth half-wave rectifier circuit provided to the second wiring line in the same direction as the third half-wave rectifier circuit.

11. An inverter circuit according to claim 9, wherein the inverting circuit is provided in a section of the second wiring line on a side of the another of the pair of transformers.

12. An inverter circuit according to claim 5, wherein the first wiring line and the second wiring line are arranged, at least in part, substantially in parallel to each other.

13. An inverter circuit according to claim 1,
wherein the detection control circuit outputs an adjusting pulse signal to the drive circuit based on the detected first signal, and
wherein the drive circuit controls the pulse signal to be output to the transformer based on the adjusting pulse signal.

14. A backlight device, comprising:
the inverter circuit according to claim 1; and
a fluorescent lamp driven by the inverter circuit.

15. A display device, comprising:
the backlight device according to claim 14; and
a display panel illuminated by the backlight device.
